(19) United States
(12) Patent Application Publication
(10) Pub. No.: US 2009/0019115 A1
(43) Pub. Date: Jan. 15, 2009

(54) Communications server objects for configuration information access

(75) Inventors: Tom Larson, Redmond, WA (US); Vladimir Grebenik, Redmond, WA (US); Michael Hamler, Kirkland, WA (US); Dian Fan, Beijing (CN)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/701,141

(22) Filed: Feb. 1, 2007

(51) Int. Cl. G06F 15/16

(52) U.S. Cl. 709/206; 709/204

(57) ABSTRACT

Architecture comprising an application programming interface (API) for representing and accessing various configuration data related to an enterprise messaging communications system. The API includes three classes for accessing stored configuration data related to enterprise recipients that can receive messages (e.g., e-mail), one or more servers that facilitate messaging communications of the enterprise, and a messaging connector for proper flow of message internal and external to the enterprise. By encapsulating these sets of configuration data into distinct classes, business logic that interprets these classes can be centralized thereby avoiding duplicate and incompatible logic.

### BACKGROUND

The advances in both IP and cellular networks serve as a catalyst for enormous amounts of information exchange. Users can utilize many different types of devices such as portable computers and cell phones to access and disseminate information from most any location. In particular, wireless and mobile capabilities are becoming principal forms of communication and data access. With the widespread deployment of wireless services mobile information workers play a key role in many corporate business operations. Employees that travel, such as sales representatives and field service technicians, for example, require access to mail, contacts information, calendar, etc., from anywhere.

Businesses realize that communications is a very important investment not only for promoting products and services, but also for maintaining employee productivity. More recent developments include enterprise-class solutions that provide security and policy-driven solutions for messaging and data exchange for computing and mobile devices. For example, collaboration systems allow employees to communicate in shared environments to discuss topics of interest and exchange information on related topics.

However, these conventional attempts at unified solutions are only partially successful. Corporate systems can typically include a blend of legacy backend and communications systems some of which are sufficiently compatible to facilitate a partial solution to existing needs. Niche vendors provide patchwork interfaces to make these systems work in some basic fashion. However, it is desirable to have a software component that provides a universal solution to the wide variety of systems and configuration data that enterprises employ.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The disclosed architecture comprises an application programming interface (API) for representing and accessing various configuration data related to an enterprise messaging communications system. The API includes three classes for accessing stored configuration data related to enterprise recipients that can receive messages (e.g., e-mail), one or more servers that facilitate messaging communications of the enterprise, and a messaging connector for proper flow of messages internal and external to the enterprise.

One elemental piece of configuration data for the communications server(s) is data associated with describing entities which can receive messages (recipients). For example, the entity can be a mailbox, an external contact, a group of recipients, a public folder, a mail agent, or other suitable entities that can receive messages. This recipient class can be identified using one or more e-mail addresses, an LDAP (lightweight directory access protocol) distinguished name, a security identifier (SID), a legacy server distinguished name, and other information such as globally unique IDs (GUIDs).

Aspects of administration and the processing of messages can request access to communications server configuration data. This can be centralized in a server class. The server class can be identified by name, a fully qualified distinguished DNS (domain names server) name, a legacy server distinguished name and other information such as GUIDs. For the proper flow of messages (e.g., e-mail) internal and external to the enterprise configuration data for a message connector object can be encapsulated in a connector class. The connector class can encapsulate a routing group identifier serving as a source of the messages and a collection of identifiers for servers serving as a source of the messages.

By encapsulating these sets of configuration data into distinct classes of a single private API, business logic that interprets these classes can be centralized thereby avoiding duplicate and incompatible logic.

In one specific implementation, the communications server is a product by Microsoft Corporation called Exchange Server™ (e.g., Exchange 2007) that includes the private API to allow applications included as part of the communications server to access the configuration data stored in the storage or data component, which can be an Active Directory™ storage system.

In another implementation, the API is XML-based for more universal access. This can mean that information associated with messaging, such as calendar information, diary and/or inbox can be populated with data from an outside application.

The API can be positioned as part of a middle-tier system for providing an interface for many different applications of the communications server system. In alternative embodiments, the API can be hosted on a backend system and/or a client.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a computer-implemented system for accessing configuration data.

FIG. 2 illustrates an exemplary system for middle-tier implementation of the innovation.

FIG. 3 illustrates a method of providing access to data in accordance with the innovation.

FIG. 4 illustrates a set of exemplary properties that can be encapsulated in the recipient class in accordance with the innovation.

FIG. 5A illustrates a first portion of exemplary code of the recipient class.

FIG. 5B illustrates a second portion of exemplary code of the recipient class.

FIG. 5C illustrates a third portion of exemplary code of the recipient class.

FIG. 6 illustrates a set of exemplary properties that can be encapsulated in the server class in accordance with the innovation.

FIG. 7A illustrates a first portion of exemplary code of the server class.

FIG. 7B illustrates a second portion of exemplary code of the server class.

FIG. 7C illustrates a third portion of exemplary code of the server class.

FIG. 7D illustrates a fourth portion of exemplary code of the server class.

FIG. 7E illustrates a fifth portion of exemplary code of the server class.

FIG. 8 illustrates a set of exemplary properties that can be encapsulated in the connector class in accordance with the innovation.

FIG. 9 illustrates exemplary code for the connector class.

FIG. 10 illustrates a system that employs alternative locations in which the API of recipient, server and connector classes can be utilized for accessing configuration information.

FIG. 11 illustrates a block diagram of a computing system operable to host the API and execute the associated classes of the disclosed architecture for obtaining configuration data.

FIG. 12 illustrates a schematic block diagram of an exemplary computing environment that facilitates access via the API classes in accordance with the innovation to obtain configuration data.

### DETAILED DESCRIPTION

The disclosed architecture comprises an application programming interface (API) for representing and accessing various configuration data related to an enterprise messaging communications system. The API (also called a driver API) includes three separate classes in a single API for accessing stored configuration data: a recipient class related to enterprise recipients that can receive messages (e.g., e-mail), a server class that represents one or more servers that can facilitate messaging communications of the enterprise, and a messaging connector class for the proper flow of message internal and external to the enterprise.

A recipient can be a mail-enabled object to which messages can be delivered. Recipient entities can include mailbox users, mail users, resource mailboxes, mail contacts, distribution groups, and dynamic distribution groups, for example.

A connector is a software component that represents a logical path between a source and a destination. A receive connector can be used to receive mail from remote mail systems based on administrator-defined address spaces. Receive connectors can be utilized to apply a customized set of limits and other configuration options that apply only to messages received from remote mail systems that match the address space that is configured on the send connector.

By encapsulating these sets of configuration data into distinct classes, business logic that interprets these classes can be centralized thereby avoiding duplicate and incompatible logic.

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

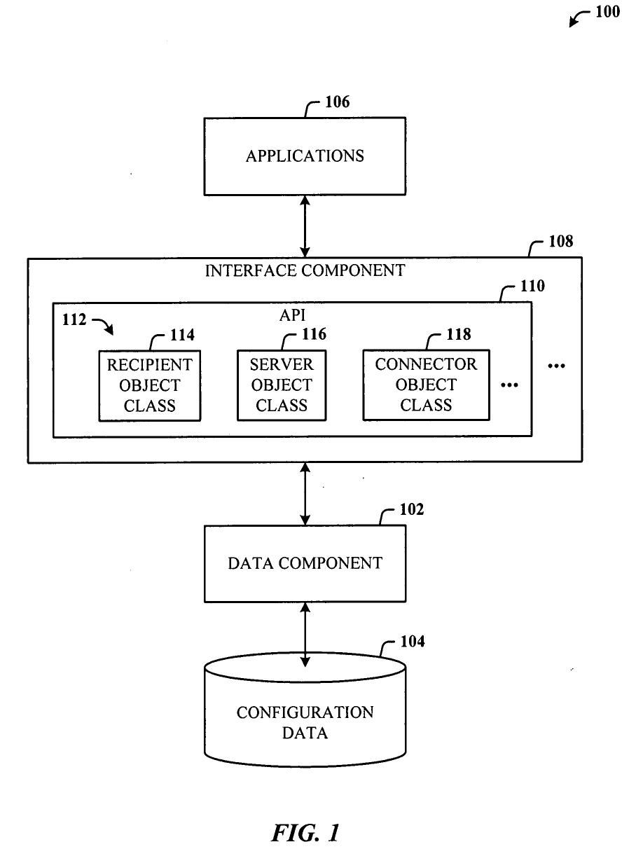

Referring initially to the drawings, FIG. 1 illustrates a computer-implemented system 100 for accessing data. The system 100 can include a data component 102 that includes a datastore 104 for storing configuration data for access by disparate communications applications 106. The system 100 can also include an interface component 108 for representing the configuration data via an API 110 (e.g., a private API) that includes classes 112, the classes 112 comprising a recipient class 114, a server class 116, and/or a connector class 118, via which the applications 106 access the configuration data of the data component 102.

Note that the interface component 108 can include other APIs for other purposes, but which are not shown here. Additionally, the API 110 can include more than the three classes 112 described.

The applications 106 can include functionality related to spam control and virus protection, messaging compliance, data replication across multiple communication servers for a enterprise that include multiple communications servers, encryption, and unified messaging for delivering different types of communications to a user inbox, such as faxes, e-mail, and voice mail, for example. Mobile messaging and access is supported by the applications 106, as well as web-based messaging and, collaboration and productivity (e.g., calendaring, resource booking, and meeting scheduling)

The messages can include data types such as text, voice, graphics, video, images, and/or audio, for example, content which can be considered part of multimedia and which can be communicated via wired and/or wireless clients. For example, a cell phone with messaging capability can send a text message that also includes captured images, short video clips, voice files, etc., all of which can be stored in an associated user storage location (e.g., user inbox or mailbox) of an enterprise communications system. The data component 102 can be associated with a single datastore 104, multiple datastores for a single server, or multiple datastores distributed across the enterprise for multiple servers.

In one implementation of the API 110, the different applications 106 are able to process messages using a variety of tools in support of devices that facilitate mobile access, web access, voice access, and e-mail access, for example. This is facilitated by technology including but not limited to, Web-based Distributed Authoring and Versioning (WebDAV), Simple Mail Transfer Protocol (SMTP), Network News Transfer Protocol (NNTP), Internet Message Access Protocol (IMAP), and Messaging Application Programming Interface (MAPI). Moreover, users can receive messages in storage locations of the datastore 104 (e.g., private mailbox folders), which can be accessed using WebDAV, Post Office Protocol version 3 (POP3), IMAP, and/or MAPI, for example.

In one specific implementation, the system 100 comprises a unified communications and collaboration software product known as Exchange Server™ (e.g., Exchange 2007) by Microsoft Corporation that includes the API 110 to allow the applications 106 included as part of the communications server to access the configuration data stored in the storage or data component 102 (and datastore 104). In another implementation, the system 100 employs Active Directory™ by Microsoft Corporation as the data component 102 and datastore 104 as a storage system. In yet another implementation, Exchange Server is employed with Active Directory as one or more of the unified communications and collaboration system(s) for an enterprise.

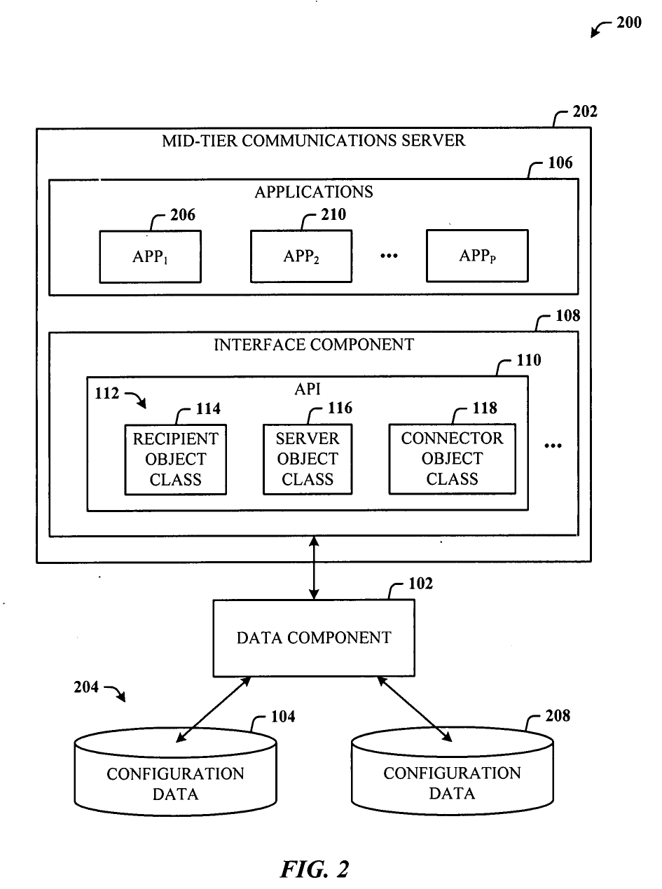

FIG. 2 illustrates an exemplary system 200 for middle-tier implementation of the innovation. The system 200 includes a mid-tier communications server 202 in which the interface component 108 is employed. The server 202 can include the data component 102 (e.g., a database subsystem, an Active Directory storage system, . . . ) for interfacing with one or more datastores 204 that store configuration data for access by the API 110 and associated classes 112. It is within contemplation of the innovation that a company can employ several of the communications servers 202 in support of a large number of users and different geographic locations. Thus, there can be many datastores 204 (e.g., that includes the datastore 104) that can store not only the configuration data, but also user mailboxes clustered in a central location and/or distributed across the enterprise geographically and topographically, for example. In all cases, the API 110 and classes 112 provide the means by which the configuration data can be located and accessed.

User access via user devices can be by way of a variety of different communications technologies and protocols communicating with the applications 106 (denoted as including APP₁, APP₂, . . . , APP_{P}, where P is a positive integer). For example, a user of a mobile client (e.g., a cell phone) can access the server 202 via IP and/or cellular networks seeking to check for messages or other related information in the user inbox of the datastore 104. Upon receiving a request from the mobile client through a first application 206, the server 202 processes the request through the interface component 108 in accordance with the protocols employed by the mobile client. The request is further processed through the API 110 and classes 112 to determine if the user is an authorized recipient (using the recipient class 114), to find the server that includes the user inbox (using the server class 116) and to process outbound messages for the user client (using the connector class 118).

Similarly, a user of a web access client (e.g., a portable computer) can access the server 202 via IP and/or cellular networks seeking to check for messages or other related information of a corresponding user inbox of a second datastore 208, for example. Upon receiving a request from the web client through a second application 210, the server 202 processes the request through the interface component 108 in accordance with the protocols employed by the web access client. The request is further processed through the API 110 and classes 112 to determine if the user is an authorized recipient (using the recipient class 114), to find the server that includes the user inbox (using the server class 116) and to process outbound messages for the user client (using the connector class 118).

Similar processes can occur for e-mail clients and voice access clients, for example. It is to be understood that other clients can be accommodated by the system 200 in addition to those clients which have been described.

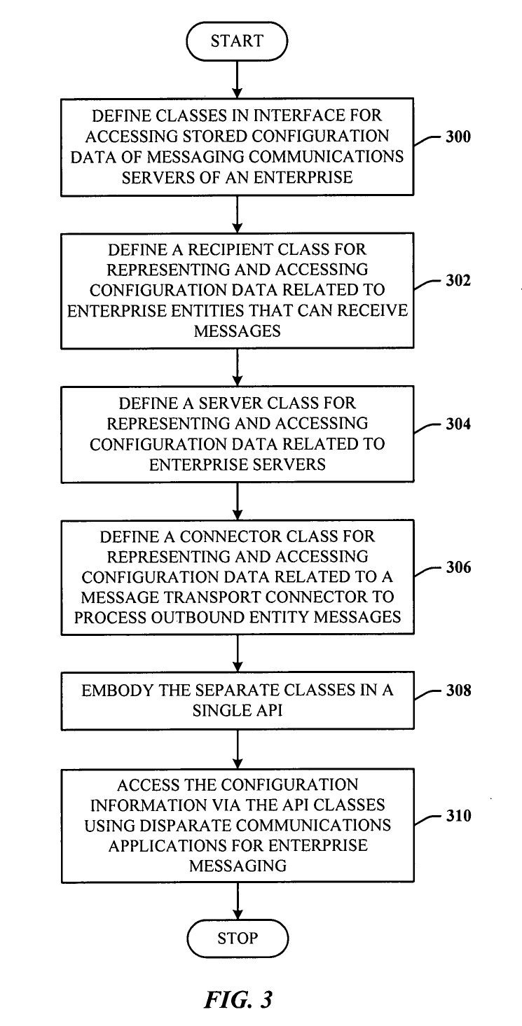

FIG. 3 illustrates a method of providing access to configuration data in accordance with the innovation. While, for purposes of simplicity of explanation, the one or more methodologies shown herein, for example, in the form of a flow chart or flow diagram, are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 300, classes are defined in an interface (e.g., API) for accessing stored configuration data associated with one or more messaging communications servers of an enterprise. The classes of the interface include: at 302, a recipient class for representing and accessing recipient configuration data related to entities of the enterprise suitable for receiving messages; at 304, a server class for representing and accessing server configuration data related to the one or more messaging communications servers of the enterprise that facilitate communication of the messages to the entities, the server class includes class members associated with server-specific messaging settings, server-specific message transportation settings, and server-specific storage settings; and at 306, a connector class for representing and accessing server configuration data related to a message transport connector of the one or more messaging communications servers of the enterprise, the connector processes outbound messages of the entities. At 308, the classes are embodied as separate classes in a single API (e.g., private). At 310, the configuration data is accessed via the classes using disparate applications of the one or more messaging communications servers to facilitate messaging communications of the enterprise.

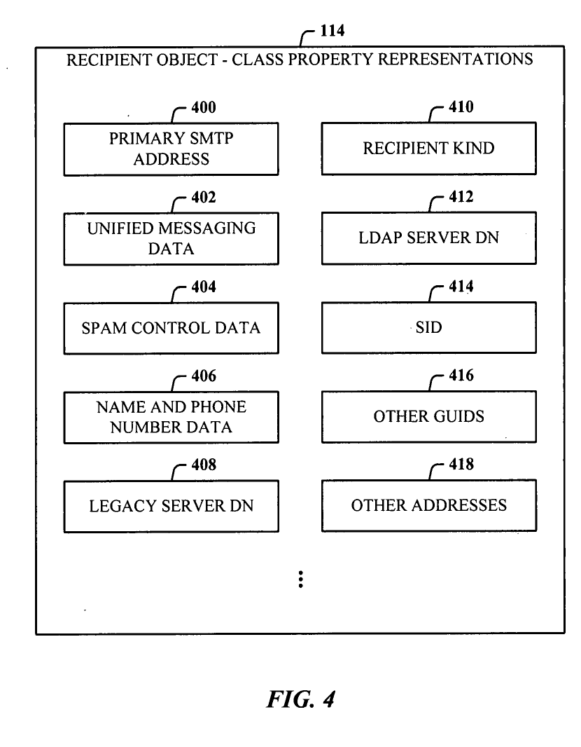

FIG. 4 illustrates a set of exemplary properties that can be encapsulated in the recipient class in accordance with the innovation. The recipient class 114 can be utilized to access configuration data associated with entities eligible to receive messages (e.g., e-mail). The entities can be user mailboxes (or inboxes), external contacts (e.g., external to the enterprise network), groups of recipients, public folders, mail agents, and other entities that can receive and/or process messages.

Properties information that can encapsulated include a primary SMTP (simple mail transport protocol) address 400, unified messaging data 402, spam control data 404, fields data 406 containing human-readable data such as name and phone number, legacy server distinguished name (DN) 408, kind data 410 specifying a kind of recipient represented, an LDAP server DN 412, a security ID 414, GUIDs 416, and a set of other e-mail addresses 418. These are only a few of the properties that can be described in the recipient class.

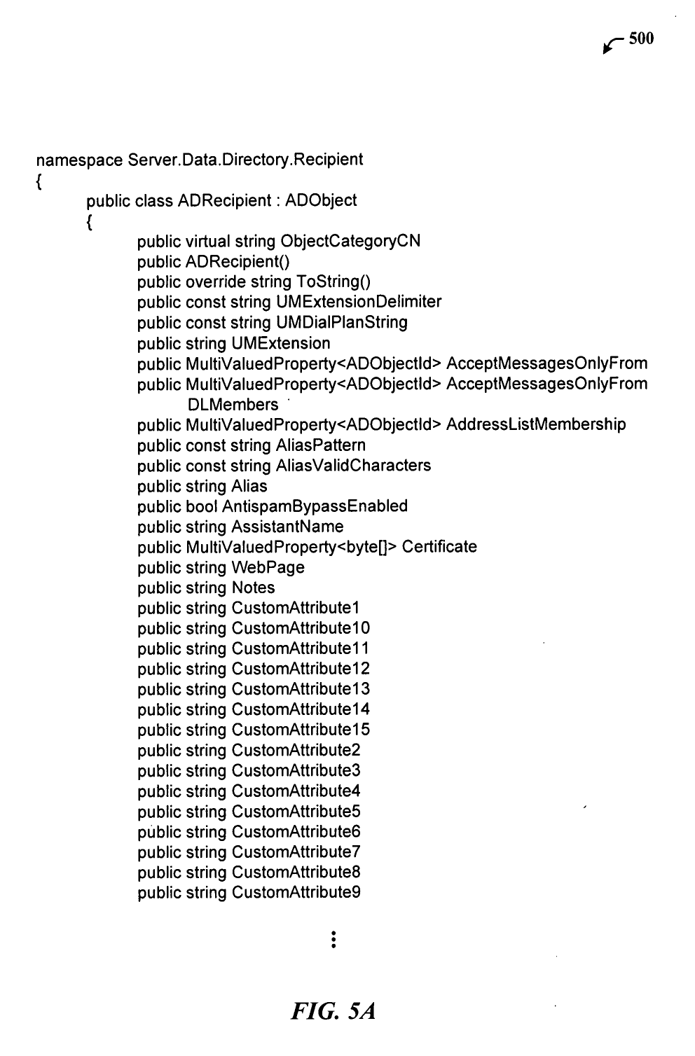

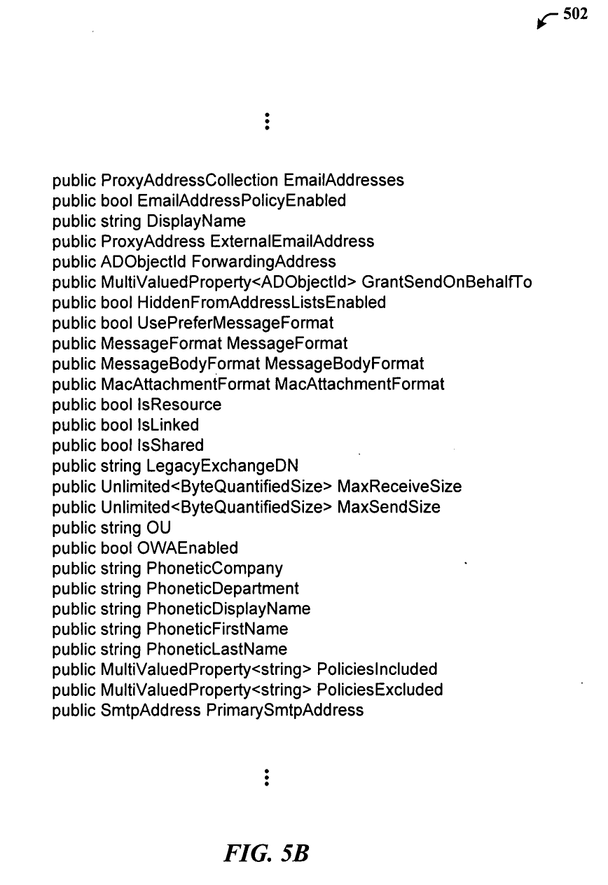

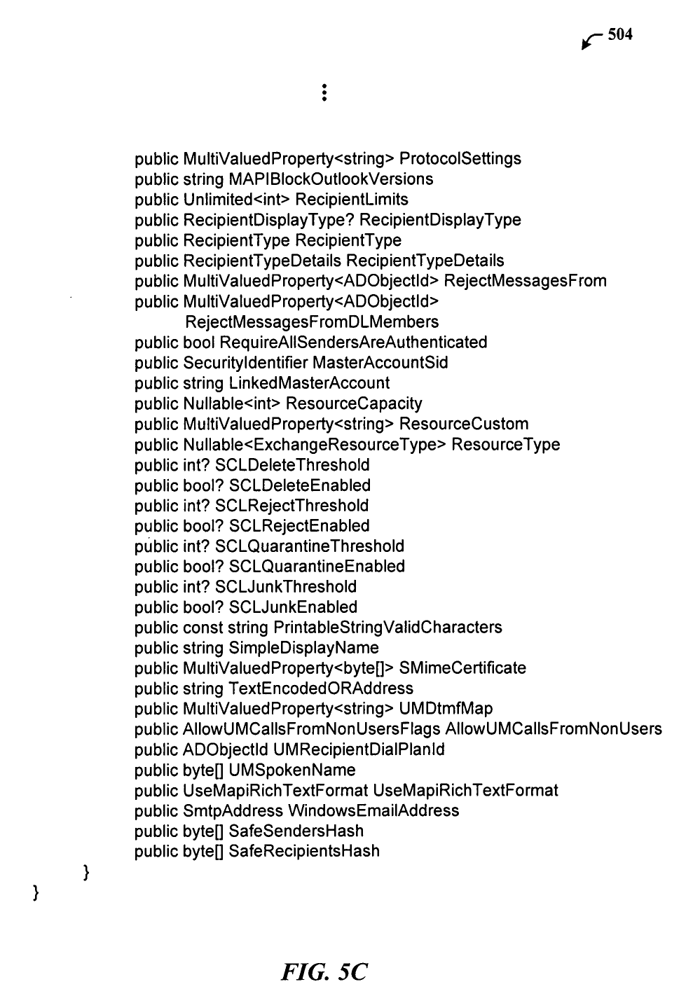

Other properties are described in association with portions of exemplary recipient class code illustrated in FIGS. 5A, 5B and 5C. Although described in the context of Exchange Server and Active Directory products by Microsoft Corporation, it is to be understood that other communications server and data storage architectures can be employed for access via the recipient class 114.

FIG. 5A illustrates a first portion 500 of exemplary code of the recipient class. As shown, other class properties for accessing configuration data can include, but are not limited to, dialing plan strings, extension information, alias processing, antis-spam controls, certificates, web pages, custom attributes, and notes. FIG. 5B illustrates a second portion 502 of exemplary code of the recipient class. Thus, the recipient class code can further employ properties associated with proxy e-mail addresses, display name, forwarding address, proxy send, hidden recipients, message formats, maximum byte size for send and receive, web access, phonetic information, include/exclude policies, and the primary SMTP address. FIG. 5C illustrates a third portion 504 of exemplary code of the recipient class. The recipient class code can further employ properties associated with protocol settings, e-mail program settings (e.g., Outlook™ by Microsoft Corporation), recipient information (e.g., limits, display type, recipient type and type details), message rejection data, sender authentication data, mast account information (e.g., SID, linked accounts), resource information (e.g., capacity, type), spam confidence level (SCL) settings, simple display name, unified messaging information (e.g., DTMF (dual tone multi-frequency) data, calls, dial plans, text formats) and, sender and recipient hashes.

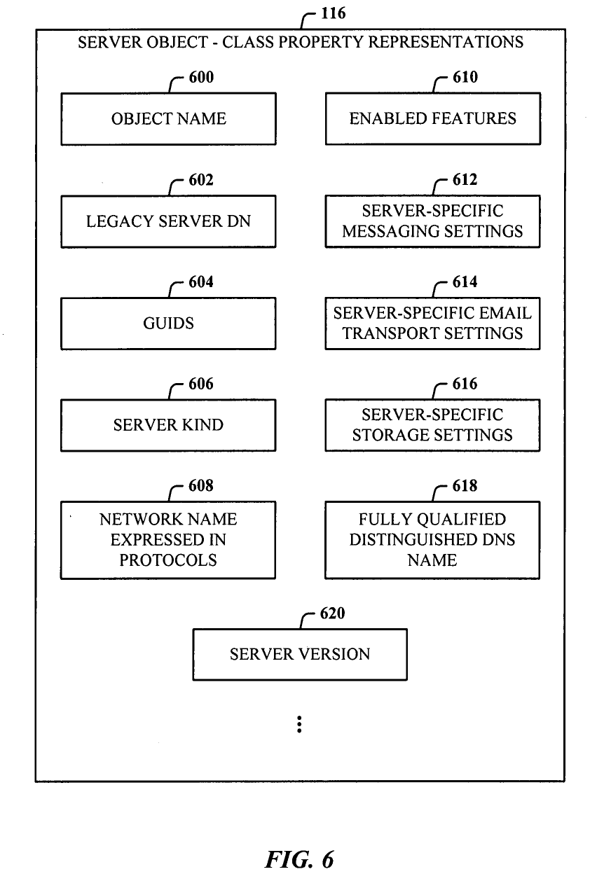

FIG. 6 illustrates a set of exemplary properties that can be encapsulated in the server class 116 in accordance with the innovation. The server class 116 can be utilized to access configuration data associated with one or more messaging communications servers of an enterprise. The properties can include, but are not limited to, an object name 600 for the server class, a legacy server DN 602, one or more GUIDs 604, server kind data 606, a network name 608 expressed in different protocols, enabled features 610, server-specific messaging settings 612, server-specific e-mail transport settings 614, server-specific storage settings 616, fully qualified distinguished DNS name 618, and server version information 620.

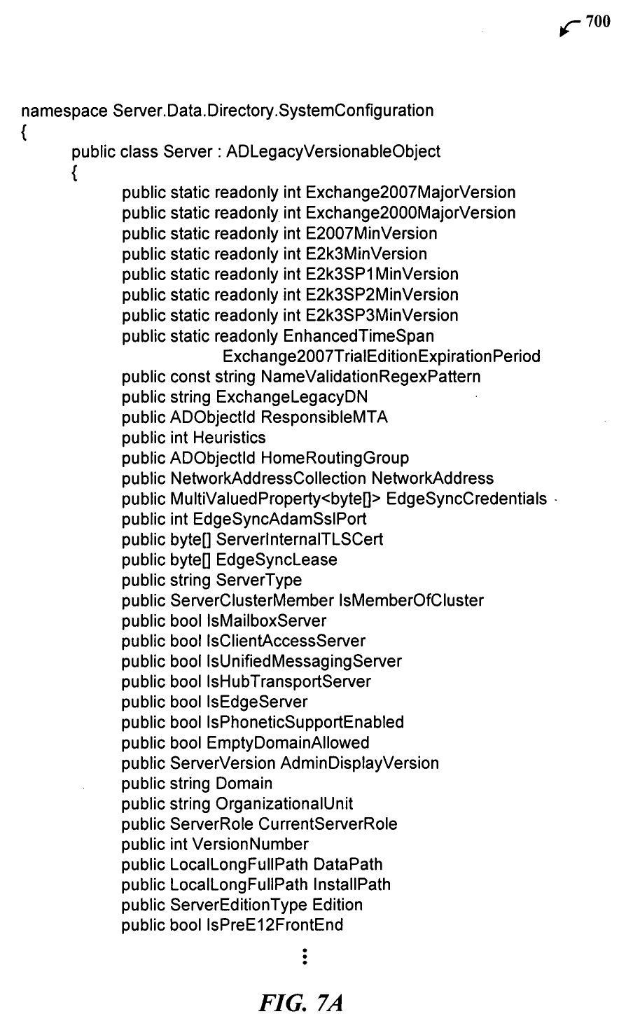

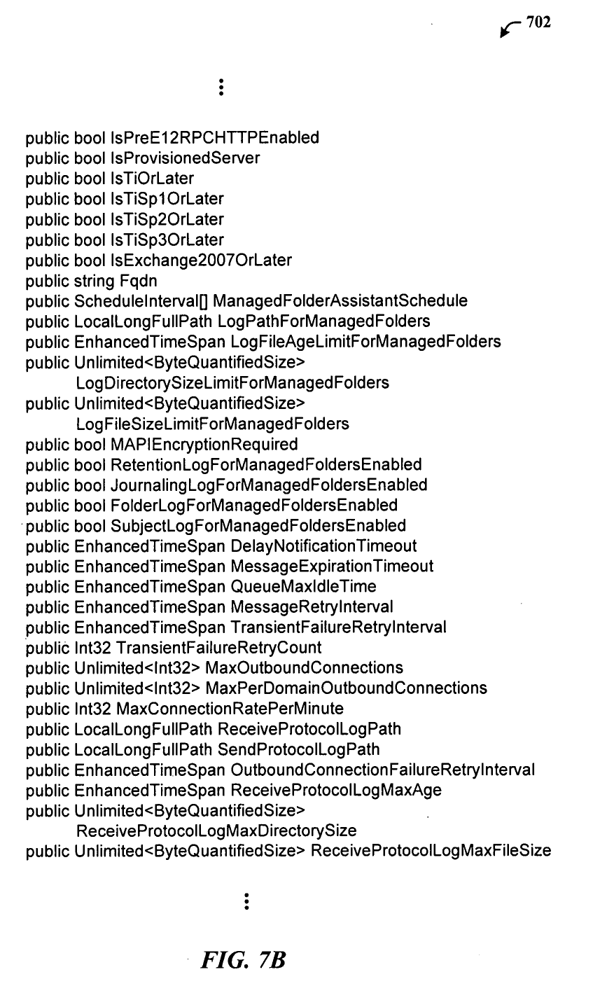

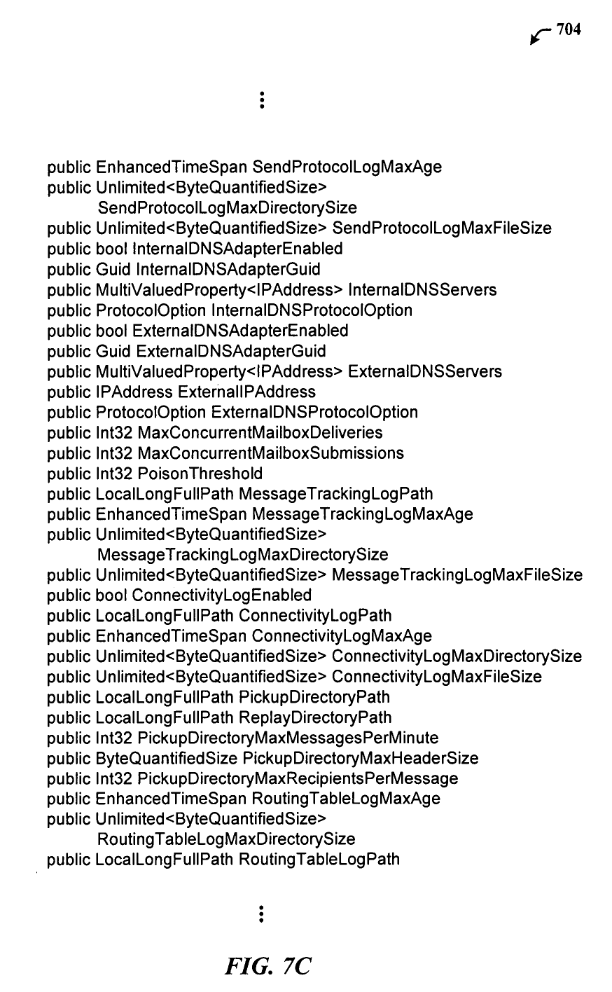

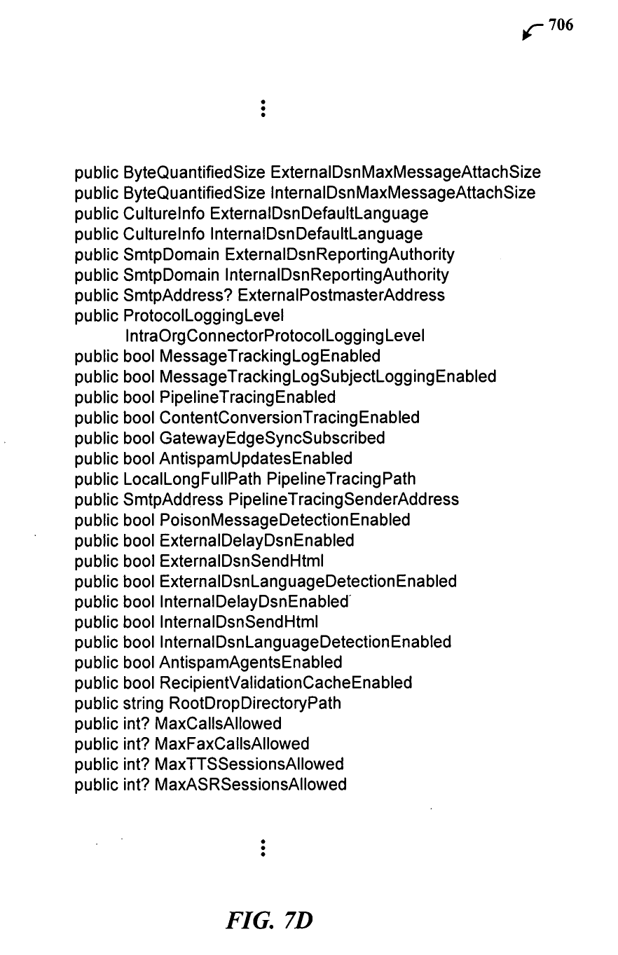

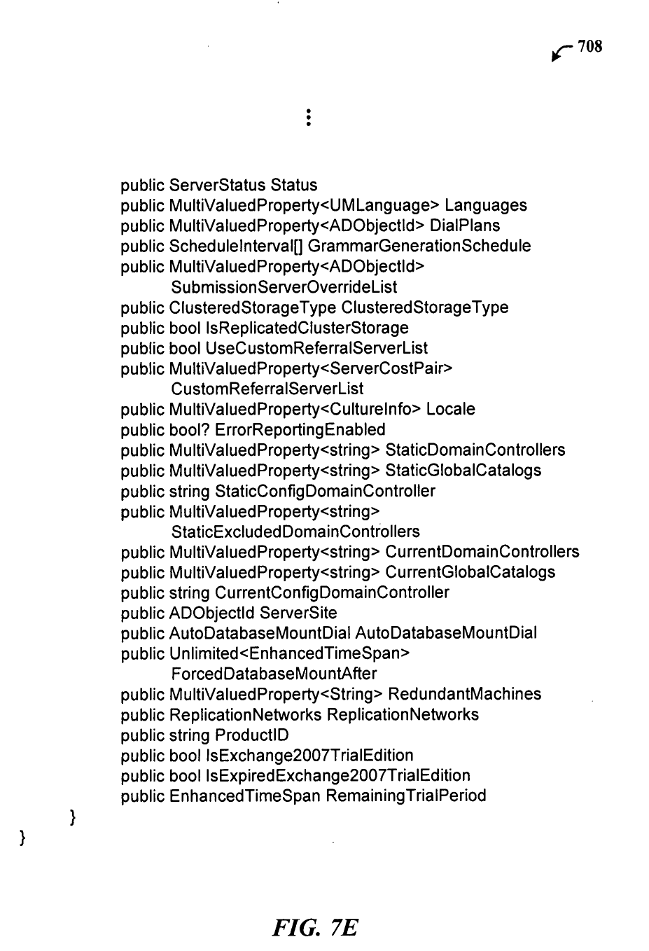

Other properties will be described in conjunction with portions of exemplary server class code illustrated in FIG. 7A-E. Again, although described in the context of Exchange Server and Active Directory products, it is to be understood that other communications server and data storage architectures can be employed.

FIG. 7A illustrates a first portion 700 of exemplary code of the server class. As shown, other class properties can include, but are not limited to, configuration data related to server version information (e.g., for Exchange Servers), server trial expiration information, name validation data, responsible message transfer agent (MTA), heuristics information, home routing group, network address collection, edge server information (e.g., credentials, ports, lease), internal server certificates, server cluster data, mailbox server, client access server, unified messaging server, transport server, edge server, phonetic support settings, domain settings, server role, administrative display version, and path information.

FIG. 7B illustrates a second portion 702 of exemplary code of the server class. Additional class properties can include, but are not limited to, configuration data related to HTTP (hypertext markup language) settings, server service packs, provisioning, fully qualified DN (fqdn), scheduling, path information, log files, encryption, timeouts, queue, message retry intervals, outbound connections, outbound connection retry intervals, age information and file size.

FIG. 7C illustrates a third portion 704 of exemplary code of the server class. Additional class properties can include, but are not limited to, protocol log aging, log directory and file size, internal/external DNS functions (e.g., enabled, GUID), mailbox data, message tracking log, connectivity log, directory path, message bandwidth settings, and routing table log.

FIG. 7D illustrates a fourth portion 706 of exemplary code of the server class. Additional class properties can include, but are not limited to, internal/external message attachment settings, internal/external reporting authority, internal/external default language, external postmaster address, protocol logging level, message tracking log, pipeline tracing settings, content conversion tracing, edge server synchronization, anti-spam settings, internal/external DSN (data source name) settings, recipient cache settings, root directory path, maximum settings for calls, faxes, TTS (text-to-speech) sessions and ASR (automatic speech recognition) sessions.

FIG. 7E illustrates a fifth portion 708 of exemplary code of the server class. Additional class properties can include, but are not limited to, server status, languages, dial plans, schedules, storage clusters, cluster replication, custom server lists, preferred culture settings, static/current domain controller and global catalog settings, database access and settings, replication networks, and product trial product settings.

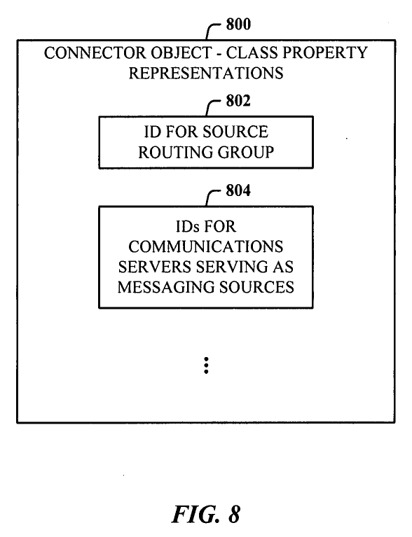

FIG. 8 illustrates a set of exemplary properties that can be encapsulated in the connector class 118 in accordance with the innovation. The connector class 118 can be utilized to access configuration data associated with the proper flow of messages (e.g., e-mail) internally and externally, based on the demands of a messaging administrator. In the context of e-mail configuration data for a mail connector object is employed to encapsulate related properties in the connector class 118. Here, the connector class can include, but is not limited to, an identifier 402 for a source routing group, and IDs for communications servers as messaging sources.

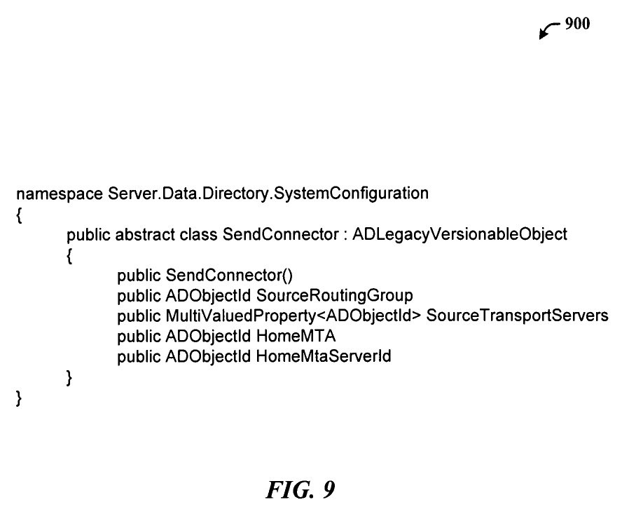

FIG. 9 illustrates exemplary code 900 for the connector class. The connector class is used to represent an e-mail transport connector, outbound from a communications server or set of servers. The connector class can form the basis of other APIs associated with SMTP connector configuration, routing group connectors, mail gateways, and foreign connectors. The configuration information encapsulated includes an identifier for the source routing group serving as the source of e-mail, for example, source transport server information, and object ID for the home MTA and home MTA server ID.

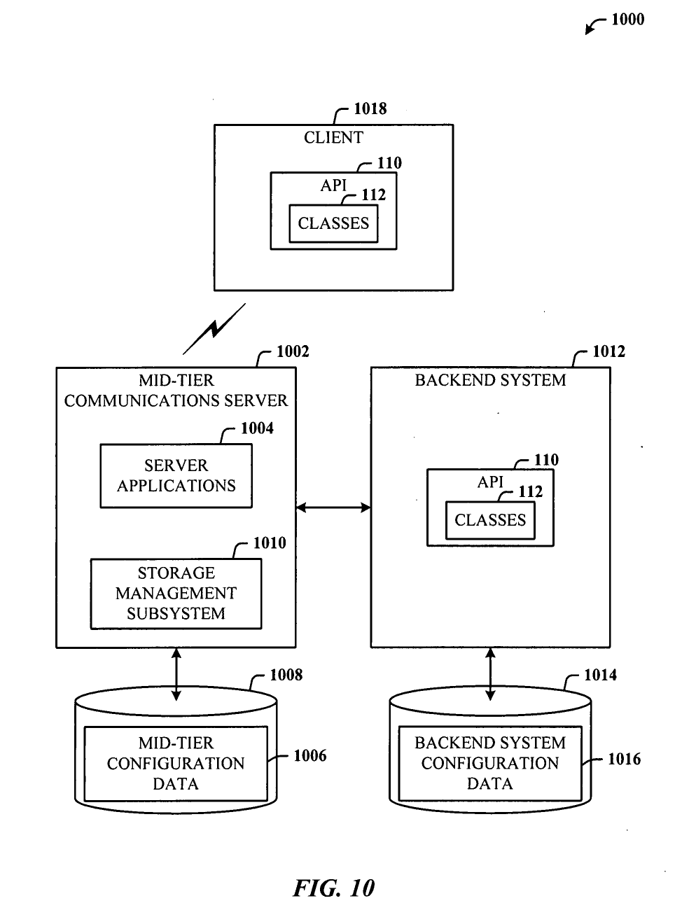

FIG. 10 illustrates a system 1000 that employs alternative locations in which the API of recipient, server and connector classes can be utilized for accessing configuration information. The system 1000 includes a mid-tier communications server 1002 for processing enterprise communications. The server 1002 can include server applications 1004 that facilitate communications from different types of user clients (e.g., cell phones, portable computers) that can be utilized in an enterprise. The server 1002 can have an associated mid-tier configuration data 1006 residing on an associated mid-tier datastore 1008, and administered by a mid-tier storage management subsystem 1010.

The system 1000 can also include a backend system 1012 as part of the enterprise that includes the API 110 and classes 112. Additionally, the backend system 1012 can also include an associated backend datastore 1014 that stores, among other things, a backend database of enterprise configuration data 1016.

In operation, when a client 1018 communicates with the enterprise in order to request access a user mailbox, configuration data should be accessed. One of the server applications 1004 can communicate the request to the backend system 1012 which processes the request through the API 110 and classes 112 to obtain the desired configuration information. The request can then be processed for routing back to the mid-tier system 1002, to the storage subsystem 1010, and ultimately, to the appropriate mailbox on the mid-tier datastore 1008. Alternatively, the request can be processed against the backend system datastore 1014, when the user mailbox resides there.

In yet another alternative implementation, the client 1018 includes the API 110 and classes 112. Thus, a mailbox request can be processed directly by the client 1018 for routing and access to the appropriate datastores, for example, the mid-tier database 1006 and/or the backend system database 1016. User authentication can then be processed at the datastore subsystem, for example, prior to granting access to the mailbox.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

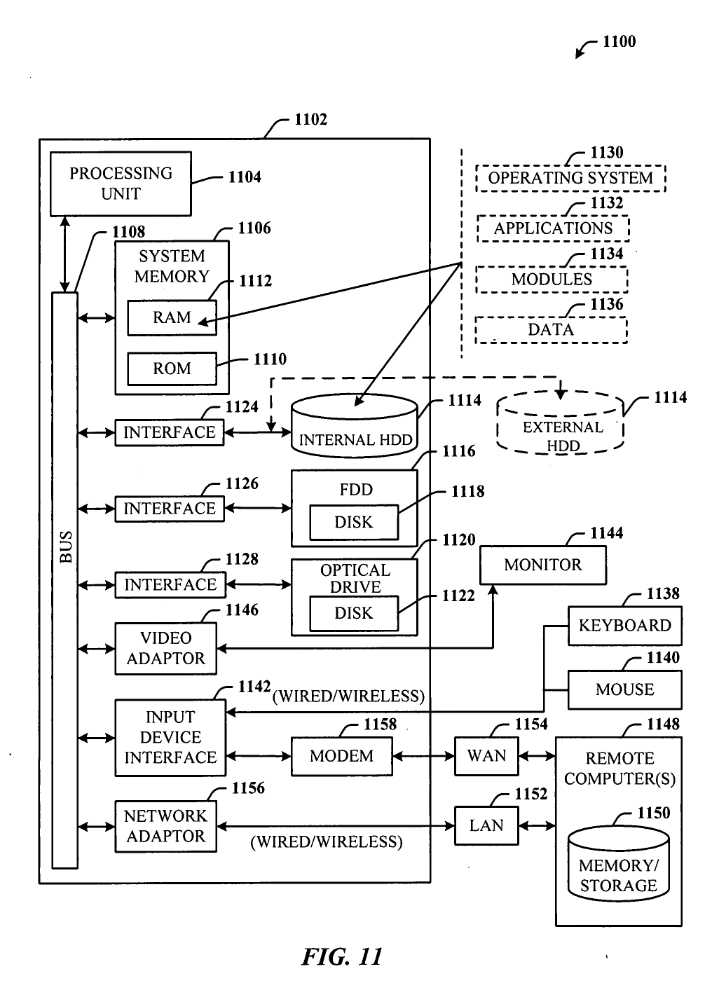

Referring now to FIG. 11, there is illustrated a block diagram of a computing system 1100 operable to execute the classes of the disclosed architecture for obtaining configuration data. In order to provide additional context for various aspects thereof, FIG. 11 and the following discussion are intended to provide a brief, general description of a suitable computing system 1100 in which the various aspects of the innovation can be implemented. While the description above is in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 11, the exemplary computing system 1100 for implementing various aspects includes a computer 1102, the computer 1102 including a processing unit 1104, a system memory 1106 and a system bus 1108. The system bus 1108 provides an interface for system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 includes read-only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer 1102 further includes an internal hard disk drive (HDD) 1114 (e.g., EIDE, SATA), which internal hard disk drive 1114 may also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed innovation.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is to be appreciated that the innovation can be implemented with various commercially available operating systems or combinations of operating systems. Here, the applications 1132 and/or data modules 1134 can include the interface component 108, the API 110 and classes 112 of FIG. 1.

A user can enter commands and information into the computer 1102 through one or more wired/wireless input devices, for example, a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE 1394 serial port, a game port, a USB port, an IR interface, etc.

A monitor 1144 or other type of display device is also connected to the system bus 1108 via an interface, such as a video adapter 1146. In addition to the monitor 1144, a computer typically includes other peripheral output devices (not shown), such as speakers, printers, etc.

The computer 1102 may operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, for example, a wide area network (WAN) 1154. Such LAN and WAN networking environments are commonplace in offices and companies, and facilitate enterprise-wide computer networks, such as intranets, all of which may connect to a global communications network, for example, the Internet.

When used in a LAN networking environment, the computer 1102 is connected to the local network 1152 through a wired and/or wireless communication network interface or adapter 1156. The adaptor 1156 may facilitate wired or wireless communication to the LAN 1152, which may also include a wireless access point disposed thereon for communicating with the wireless adaptor 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

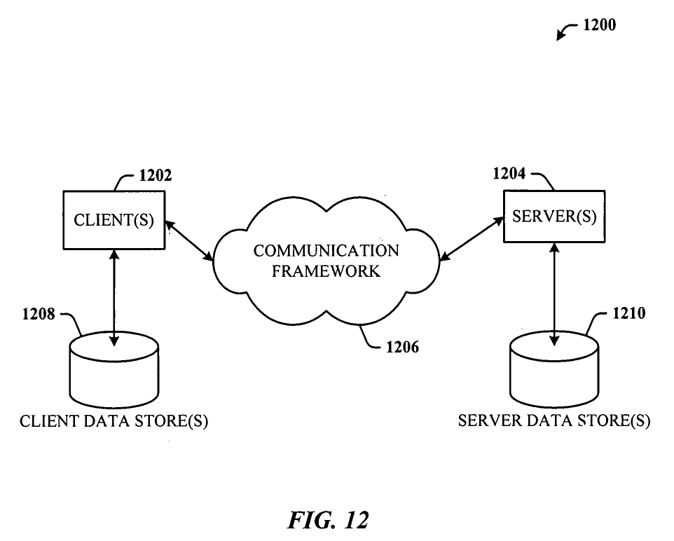

Referring now to FIG. 12, there is illustrated a schematic block diagram of an exemplary computing environment 1200 that facilitates access via the API classes in accordance with the innovation to obtain configuration data. The system 1200 includes one or more client(s) 1202. The client(s) 1202 can be hardware and/or software (e.g., threads, processes, computing devices). The client(s) 1202 can house cookie(s) and/or associated contextual information by employing the subject innovation, for example.

The system 1200 also includes one or more server(s) 1204. The server(s) 1204 can also be hardware and/or software (e.g., threads, processes, computing devices). The servers 1204 can house threads to perform transformations by employing the architecture, for example. One possible communication between a client 1202 and a server 1204 can be in the form of a data packet adapted to be transmitted between two or more computer processes. The data packet may include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

The clients 1202 can includes the client 1018 of FIG. 10, for example. The servers 1204 can include the mid-tier server 202 of FIG. 2 and the backend system 1012 and associated datastores (1008 and 1014) of FIG. 10.

What has been described above includes examples of the disclosed innovation. It is, of course, not possible to describe every conceivable combination of components and/or methodologies, but one of ordinary skill in the art may recognize that many further combinations and permutations are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system for accessing data, comprising:
a data component of a communications server for storing configuration data for access by disparate communications applications; and
an interface component for representing the configuration data comprising at least one of a recipient class, a server class, or a connector class, via which the applications access the configuration data of the data component.

2. The system of claim 1, wherein members of the recipient class represent configuration data related to entities that receive messages.

3. The system of claim 2, wherein the entities include at least one of a mailbox, external contact, group of recipients, public folder, or a mail agent.

4. The system of claim 2, wherein the recipient class includes identification information that comprises at least one of an e-mail address, an LDAP (lightweight directory access protocol) distinguished name, a security identifier, or a legacy server distinguished name.

5. The system of claim 1, wherein members of the server class represent configuration data related to communications servers of an enterprise.

6. The system of claim 5, wherein the configuration data related to the communications servers includes at least one of a distinguished name of a legacy server, a network name for each of the communications servers expressed for one or more network protocols, version information of each of the communications servers, kind information of each of the communications servers, or features enabled on each of the communications servers.

7. The system of claim 6, wherein the configuration data related to the communications servers and accessible via the server class includes at least one of server-specific messaging settings, server-specific e-mail transport settings, or server-specific storage settings.

8. The system of claim 1, wherein members of the connector class represent configuration data related to at least one of messages outbound from the communications server or a group of communications servers of an enterprise.

9. The system of claim 8, wherein the configuration data represented by the members of the connector class includes an identifier of a server routing group serving as a source of the messages, and a collection of identifiers of communications servers that are sources of the messages.

10. The system of claim 1, wherein the recipient class, server class and connector class are embodied as a single interface via which the applications access the configuration data of the data component.

11. The system of claim 1, wherein the data component and interface component are part of a middle-tier messaging communications system.

12. A computer-implemented method of accessing data, comprising:
defining classes in an interface for accessing stored configuration data associated with one or more messaging communications servers of an enterprise, the classes of the interface include,
a recipient class for representing and accessing recipient configuration data related to entities of the enterprise suitable for receiving messages;
a server class for representing and accessing server configuration data related to the one or more messaging communications servers of the enterprise that facilitate communication of the messages to the entities, the server class includes class members associated with server-specific messaging settings, server-specific message transportation settings, and server-specific storage settings; and
a connector class for representing and accessing server configuration data related to a message transport connector of the one or more messaging communications servers of the enterprise, the connector processes outbound messages of the entities; and
accessing the configuration data via the classes using disparate applications of the one or more messaging communications server to facilitate messaging communications of the enterprise.

13. The method of claim 12, wherein the messages include e-mail messages.

14. The method of claim 12, further comprising routing the messages internally and externally of the enterprise based on the configuration data accessed via the connector class.

15. The method of claim 12, further comprising encapsulating in the connector class a representation for a routing group serving as a source of e-mail.

16. The method of claim 12, further comprising encapsulating in the connector class a collection of identifiers of servers serving as a source of e-mail messages.

17. The method of claim 12, further comprising encapsulating in the server class and recipient class legacy communications server distinguished names for accessing configuration data associated therewith.

18. The method of claim 12, further comprising encapsulating in the connector class a server network name expressed for multiple network protocols.

19. The method of claim 12, further comprising encapsulating in the recipient class spam control settings and authentication information.

20. A computer-implemented system, comprising:
computer-implemented means for accessing stored configuration data via middle-tier classes of an API, the configuration data associated with one or more messaging communications servers of an enterprise;
computer-implemented means for representing and accessing recipient configuration data related to entities of the enterprise suitable for receiving messages, via a recipient class;
computer-implemented means for representing and accessing server configuration data related to the one or more messaging communications servers of the enterprise that facilitate communication of the messages to the entities, via a server class;
computer-implemented means for representing and accessing server configuration data related to outbound messages of the one or more messaging communications servers of the enterprise, via a connector class; and
computer-implemented means for accessing the configuration data via the classes using disparate applications of the one or more messaging communications server to facilitate messaging communications of the enterprise.
